(19) United States
(12) Patent Application Publication
(10) Pub. No.: US 2003/0177488 A1
(43) Pub. Date: Sep. 18, 2003

(54) Systems and methods for media audience measurement

(76) Inventors: Geoff S. Smith, Pasadena, MD (US); Eric Kestler, Potomac, MD (US); Joan G. FitzGerald, Arlington, VA (US); Martin Roth, Hoboken, NJ (US); Cheryl Mesnard, Owings Mill, MD (US); Hui Hu, Clarksville, MD (US)

Correspondence Address: ST. ONGE STEWARD JOHNSTON & REENS, LLC, 986 BEDFORD STREET, STAMFORD, CT, 06905-5619, US

(21) Appl. No.: 10/095,791

(22) Filed: Mar. 12, 2002

(51) Int. Cl. H04N 7/16; H04H 9/00; G06F 3/00; H04N 5/445; G06F 13/00; H04N 7/173

(52) U.S. Cl. 725/9; 725/11; 725/14; 725/46; 725/109; 725/112; 725/113

(57) ABSTRACT

The invention relates to systems and methods for use in carrying out media audience measurements. Media data and data gathering software are communicated to a user system from a content server. The user system communicates a media audience message to an audience surveying system which stores media audience data based on the media audience message.

### FIELD OF THE INVENTION

The invention relates to systems and methods for use in carrying out measurements of audiences for media data.

### BACKGROUND OF THE INVENTION

Measurement of Internet audiences is typically conducted either through sample-based surveys or server log file based surveys.

Sample-based surveys usually require survey companies to measure Internet audiences by randomly selecting and requesting households to participate in the survey by allowing their Internet usage to be monitored. Households that consent to such monitoring are sent software, which is to be installed on their computers to capture their computer activity. This activity includes Internet content, quantity of Internet requests, time spent on the computer, and other data. The data that is collected is transmitted back to the survey companies for recordation. The need to recruit the participants is a substantial drawback.

Server log file based surveys require companies to use server log files as the basis for measuring Internet audience. This approach generally involves measuring Internet usage by recording activity by the server from which Internet content is streamed or delivered. The information gathered includes a client's address, content identifier, date/time stamp, and in the case of streamed media content, player ID, duration, start time, and/or end time.

A disadvantage often associated with the server log file approach is that the information which may be obtained is limited to that which is available in the server log files. For example, such log files do not include demographic data for users. While the users' IP addresses are included in the server log files, a great many users access the Internet through ISP's which reassign IP addresses to others as the users go off line. It is not possible in these circumstances, therefore, to identify the users based solely on the contents of the server log files. Another disadvantage is the delay between the time the log files are supplied to measuring companies and the time the measuring companies process the log files into a useable report.

### SUMMARY OF THE INVENTION

The term “data” as used herein means any indicia, signals, marks, symbols, domains, symbol sets, representations and any other physical form or forms representing information, whether permanent or temporary, whether visible, audible, acoustic, electric, magnetic, electromagnetic or otherwise manifested.

The term “media data” as used herein means data which is widely accessible, whether over-the-air, or via cable, satellite, network, internetwork (including the Internet), distributed on storage media, or otherwise, without regard to the form or content thereof, and including but not limited to audio data and video data.

The terms “audience” and “audience member” mean a person or persons, as the case may be, who access media data in any manner, whether alone or in one or more groups, whether in the same or various places, and whether at the same time or at various different times.

The terms “survey” and “surveying” mean an activity or activities, or conducting any such activity or activities, which gather data concerning usage of media data by an audience or an audience member, including but not limited to, data concerning the media data accessed, its source and/or data concerning the audience or audience member.

The term “presentation” as used herein means data in a form perceptible to a user, whether by sight, hearing, touch or otherwise, or any combination of these.

The term “network” as used herein includes both networks and inter-networks of all kinds, including the Internet, and is not limited to any particular network or inter-network.

The term “user system” as used herein refers to any software, devices or combinations thereof which are useful for requesting, receiving, or presenting media data for a user.

The terms “communicate” and “communicating” as used herein include both conveying data from a source to a destination, and delivering data to a communications medium, system or link to be conveyed to a destination. The term “communication” as used herein means the act of communicating or the data communicated, as appropriate.

The term “Internet content” as used herein means audio and/or video media data communicated to a user system via the Internet.

The term “processor” as used herein means processing devices, apparatus, programs, circuits, systems and subsystems, whether implemented in hardware, software or both, and includes both individual units and groups of units.

The term “random value data” as used herein includes both data produced at random and data produced through a pseudo-random process.

The terms “random” and “randomly” as used herein refer to both random actions or processes and pseudo-random actions or processes.

In accordance with an aspect of the present invention, a method is provided for surveying media data audiences. The method comprises communicating media data from a content server to a user system via a network; communicating data gathering software associated with the media data from the content server to the user system via the network; without user intervention communicating an audience survey message from the user system under the control of the data gathering software to an audience surveying system; in response to the audience survey message, communicating a survey presentation message from the audience surveying system to the user system, the survey presentation message including survey presentation instructions; controlling the user system by means of the survey presentation instructions to produce a survey presentation for a media audience member; receiving survey response data for an audience member in the user system; and communicating the survey response data from the user system to the audience surveying system via the network.

In accordance with another aspect of the present invention, a system is provided for surveying media data audiences. The system comprises media data communicating means for communicating media data from a content server to a user system via a network; software communicating means for communicating data gathering software associated with the media data from the content server to the user system via the network; means for communicating an audience survey message without user intervention from the user system under the control of the data gathering software to an audience surveying system; means for communicating a survey presentation message from the audience surveying system to the user system in response to the audience survey message, the survey presentation message including survey presentation instructions; presenting means for producing a survey presentation for a media audience member under the control of the survey presentation instructions; receiving means for receiving survey response data for an audience member in the user system; and means for communicating the survey response data from the user system to the audience surveying system.

In accordance with a further aspect of the present invention, a method is provided for surveying media data audiences. The method comprises receiving media data at a user system from a content server communicated via a network; receiving data gathering software associated with the media data at the user system from the content server communicated via the network; without user intervention, communicating a media audience message from the user system under the control of the data gathering software to an audience surveying system; receiving a survey presentation message at the user system from the audience surveying system, the survey presentation message including survey presentation instructions; controlling the user system by means of the survey presentation instructions to produce a survey presentation for an audience member; receiving survey response data for an audience member in the user system; and communicating the survey response data from the user system to the audience surveying system.

In accordance with yet another aspect of the present invention, a system is provided for gathering and communicating media data audience survey data by means of a user system. The system comprises means for receiving media data at a user system from a content server via a network; means for communicating a media audience message without user intervention from the user system to a survey system indicating receipt of the media data; presentation control means for controlling the user system to produce a survey presentation for an audience member based on a survey request message received from the survey system; means for receiving survey response data for an audience member in the user system; and means for communicating the survey response data from the user system to the survey system.

In accordance with still another aspect of the present invention, a method is provided for surveying media data audiences. The method comprises receiving an audience survey message from a user system identifying media data received thereby from a content server; producing user system eligibility data by assigning random value data to the user system and comparing the random value data to a predetermined sample size value; in response to the audience survey message and based on the user system eligibility data, communicating a survey presentation message to the user system, the survey presentation message including survey presentation instructions; and receiving survey response data from the user system.

In accordance with yet a further aspect of the present invention, a system is provided for surveying media data audiences. The system comprises means for receiving an audience survey message from a user system identifying media data received thereby from a content server; means for producing user system eligibility data by assigning random value data to the user system and comparing the random value data to a predetermined sample size value; means for communicating a survey presentation message to the user system in response to the audience survey message and based on the user system eligibility data, the survey presentation message including survey presentation instructions; and means for receiving survey response data from the user system.

In accordance with a yet still further aspect of the present invention, a method is provided for gathering data for producing media data audience reports. The method comprises communicating media data from a content server to a user system via a network; communicating data gathering software associated with the media data from the content server to the user system via the network; without user intervention, communicating a media audience message from the user system under the control of the data gathering software to an audience surveying system; and storing media audience data in the audience surveying system based on the media audience message.

In accordance with another aspect of the present invention, a system is provided for gathering data for producing media data audience reports. The system comprises media data communicating means for communicating media data from a content server to a user system via a network; software communicating means for communicating data gathering software associated with the media data from the content server to the user system via the network; media audience message communicating means for communicating a media audience message from the user system under the control of the data gathering software and without user intervention to an audience surveying system; and means for storing media audience data in the audience surveying system based on the media audience message.

In accordance with a further aspect of the present invention, a method is provided for producing data for use in preparing media data audience reports. The method comprises receiving media data at a user system from a content server communicated via a network; receiving data gathering software associated with the media data at the user system from the content server communicated via the network; and communicating a media audience message from the user system under the control of the data gathering software and without user intervention to an audience surveying system.

In accordance with a still further aspect of the present invention, a system for producing data for use in preparing media data audience reports is provided. The system comprises media data receiving means for receiving media data at a user system from a content server communicated via a network; software receiving means for receiving data gathering software associated with the media data at the user system from the content server communicated via the network; and media audience message communicating means programmed by the data gathering software to communicate a media audience message without user intervention from the user system to an audience surveying system.

In accordance with yet another aspect of the present invention, a method is provided of controlling a user system to provide media data usage data to an audience surveying system. The method comprises communicating media data from a content server to a user system via a network; and, communicating data gathering software associated with the media data from the content server to the user system via the network; wherein the data gathering software is communicated asynchronously with respect to the media data from the content server.

In accordance with a yet still further aspect of the present invention, a system is provided for controlling a user system to provide media data usage data to an audience surveying system. The system comprises means for communicating media data from a content server to a user system via a network; and software communicating means for communicating data gathering software associated with the media data from the content server to the user system via the network; wherein the software communicating means serves to communicate the data gathering software from the content server asynchronously with respect to the media data.

In accordance with still another aspect of the present invention, a system for gathering data for measuring a media data audience is provided. The system comprises a user system; and software received contemporaneously with the media data and loaded onto the user system for communicating an indication of media data usage by the user system without user intervention.

In accordance with yet another aspect of the present invention, a method of gathering data for a media data usage survey is provided. The method comprises producing random value data; assigning the random value data to a media data user system; producing selection data based on a desired sample size for a media usage survey; determining whether the media data user system is eligible for the media usage survey based on the random value data and the selection data; and if the media data user system is eligible for the media usage survey, including media usage data from the media data user system in the media usage survey.

In accordance with a yet still further aspect of the present invention, a system is provided for gathering data for a media data usage survey. The system comprises random value data producing means for producing random value data; random value data assigning means for assigning the random value data to a media data user system; selection data producing means for producing selection data based on a desired sample size for a media usage survey; eligibility determining means for determining whether the media data user system is eligible for the media usage survey based on the random value data and the selection data; and means for including media usage data from the media data user system in the media usage survey on the condition that the media data user system is determined to be eligible for the media usage survey.

The invention and particular features and advantages thereof will become more apparent from the following detailed description of certain advantageous embodiments considered with reference to the accompanying drawings.

### BRIEF DESCRIPTION OF THE DRAWINGS

FIG. 1 illustrates a system for producing data for use in preparing media data usage reports, in accordance with certain embodiments of the present invention;

FIG. 2 illustrates a content server of the system illustrated in FIG. 1;

FIG. 3 illustrates a user system included in the system of FIG. 1;

FIG. 4 illustrates a survey system included in the system of FIG. 1;

FIGS. 5A through 5E together provide a flow chart for illustrating an operation of the system of FIG. 1; and

FIG. 6 is a flow chart for illustrating a further operation of the system of FIG. 1.

### DETAILED DESCRIPTION OF CERTAIN ADVANTAGEOUS EMBODIMENTS

In certain embodiments of the present invention, data is gathered for producing estimates of audiences for predetermined media data. The gathered data includes both access data indicating the accessed media data or a source thereof, as well as audience demographic data. In certain ones of such embodiments, the gathered data includes Internet content access data indicating Internet content accessed by a user or its source.

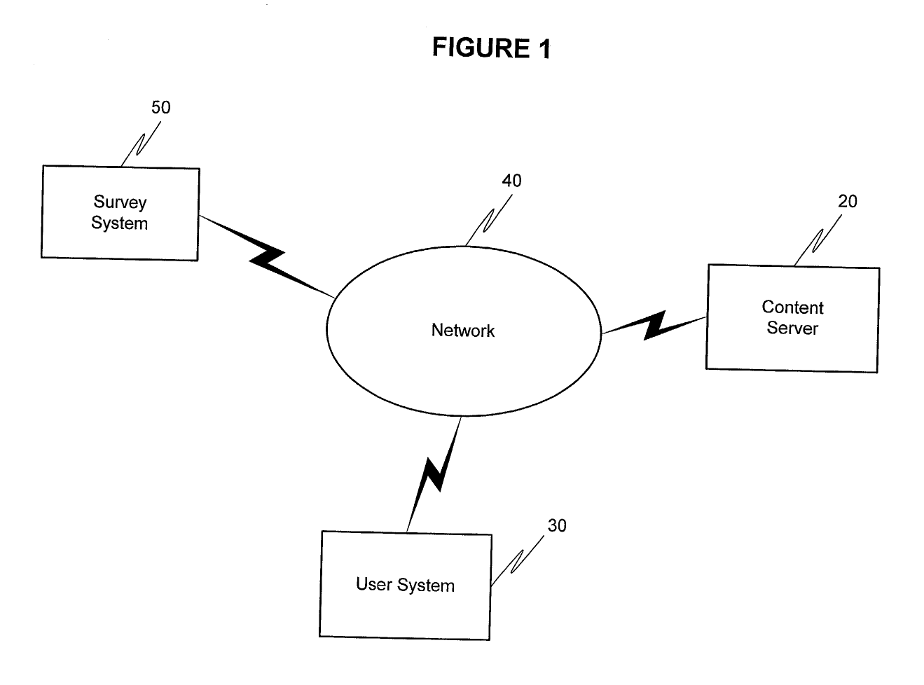

FIG. 1 illustrates such a system in accordance with certain embodiments of the invention which gathers data concerning usage of predetermined media data delivered from one or more content servers 20 to a user system 30 via a network 40. The content servers 20 and user system 30 cooperate with the survey system 50, by means of communications through the network 40 to gather and store data concerning the usage of media data supplied by the content servers 20 to the user system 30.

The system of FIG. 1 is particularly useful, although not exclusively useful, for gathering data concerning the usage of predetermined streaming media data supplied by the content servers 20 to the user system 30. Streaming media data as used herein means Internet content which is played as portions thereof are received. Streaming media data are presented by content providers to users in many different ways. An Internet-only genre channel, for example, is a collection of archived songs falling within a recognized category, such as R&B, classic rock, Christian, movie themes, etc. Some content providers enable users to define their own collections, termed user-created genre channels. Still further, programs combine streams having similar subject matter and which often vary in length. Streaming media data also include data streams corresponding to over-the-air radio stations. Still other streaming media data present live sporting events. All of the foregoing types of streaming media data can also be archived for on-demand access. However, these are simply examples of the many ways in which streaming media data can be presented to users.

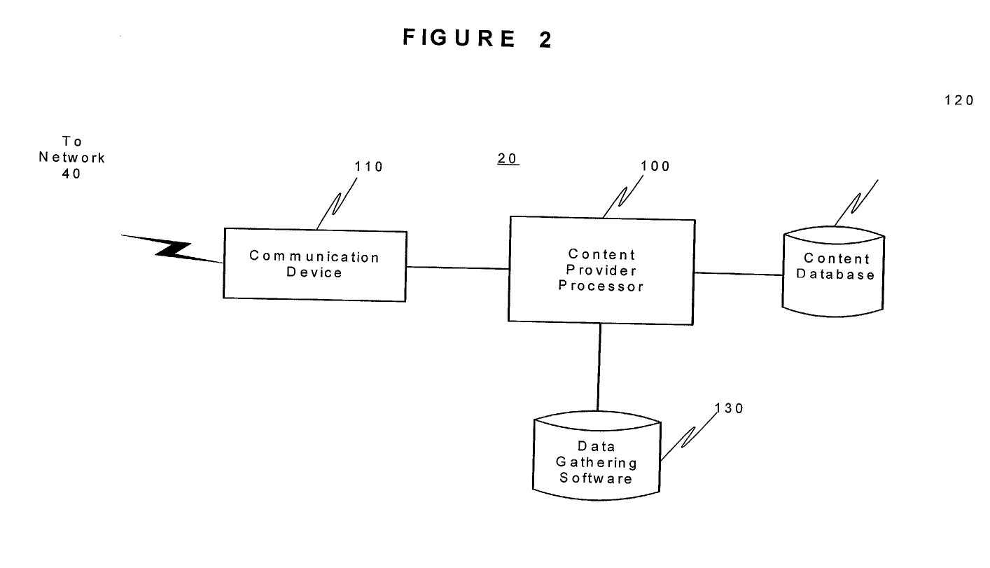

FIG. 2 illustrates a typical one the content servers 20 of the FIG. 1 system. The functions of the content server 20 of FIG. 2 are controlled by a content provider processor 100 which communicates with the network 40 via a communication device 110. The content to be supplied by the content server 20 is stored in a content database 120 from which it is read by the processor 100 and communicated to the user system 30 by the communication device 110, in response to a request for the content received by the content server 20 from the user system 30. The content server 20 also includes data gathering software 130 which the content provider processor 100 also supplies to the user system 30 in response to a request for content received from the system 30. As described in greater detail below, the data gathering software 130 after its receipt by the user system 30 from the content server 20, controls the user system 30 to cooperate with survey system 50 to supply media usage data thereto for use in preparing reports concerning the usage of media data.

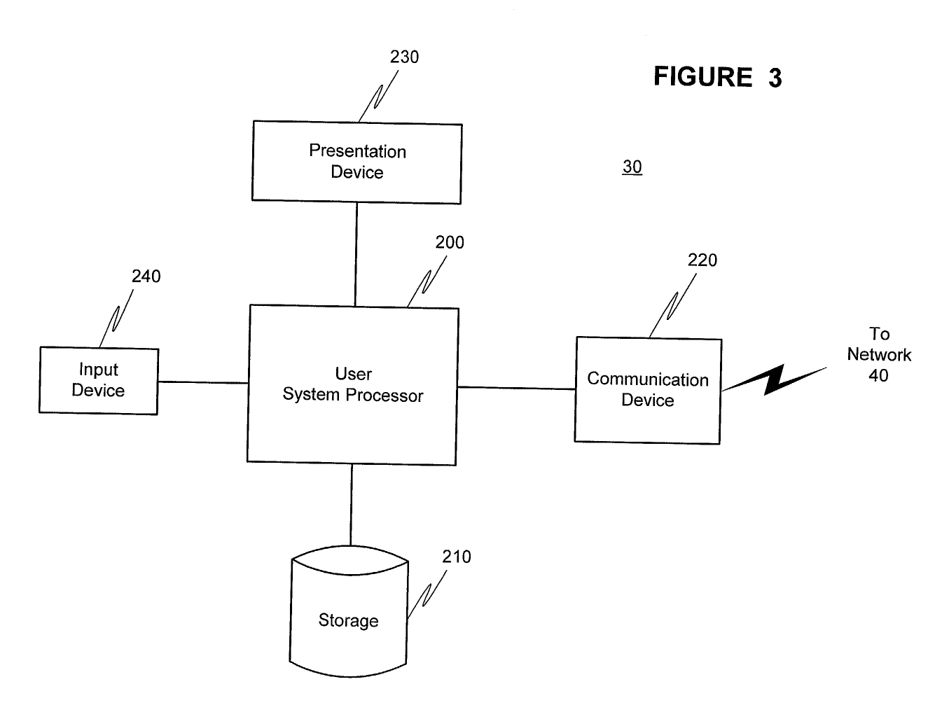

The user system 30 of FIG. 1 is illustrated in greater detail in FIG. 3. The system 30 includes a user system processor 200, controlled by software stored in non-volatile storage 210, for controlling the system 30. The processor 200 communicates with one or more of the content servers 20 and the survey system 50 via the network 40 by means of a communication device 220. The processor 200 also communicates with a presentation device 230 for presenting media data in a comprehensible form to a user. The presentation device may be an image reproduction device, an audio reproduction device, a tactile presentation device, or the like. The user system processor 200 also communicates with an input device 240 which provides instructions from the user to the processor 200 in order to select media data available from the content servers 20 for presentation by means of the device 230. The input device 240 is also used in certain embodiments to receive data from the user concerning usage of media data. The data received by the input device 240 from the user for this purpose includes in certain embodiments, demographic data concerning one or more users.

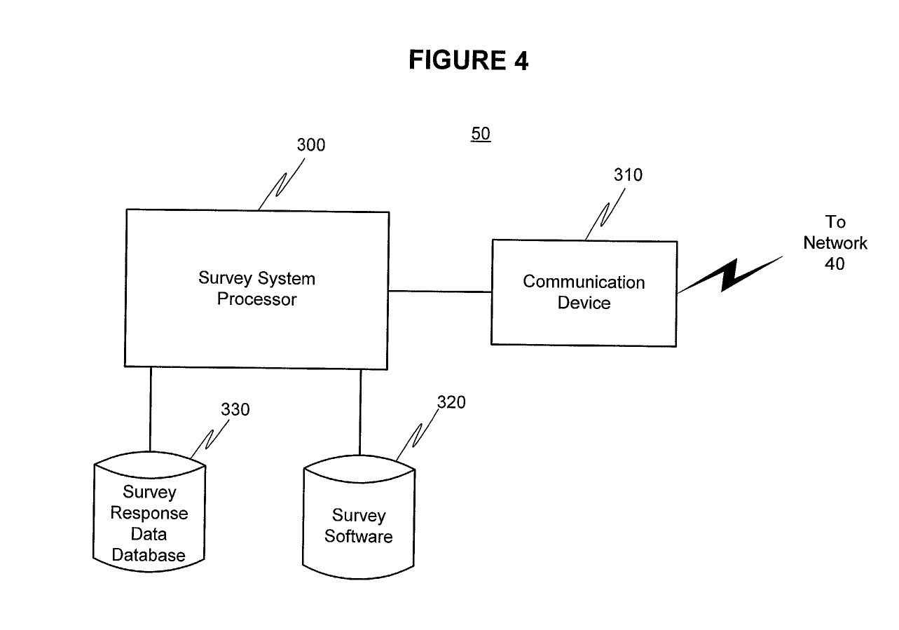

FIG. 4 illustrates the survey system 50 of FIG. 1. The survey system 50 includes a survey system processor 300 which communicates with the user system 30 via the network 40 by means of a communication device 310. The functions of the processor 300 are controlled by means of survey software 320 accessible to the processor 300 from nonvolatile storage. The processor 300, under the control of the survey software 320, receives and stores survey response data in a database 330.

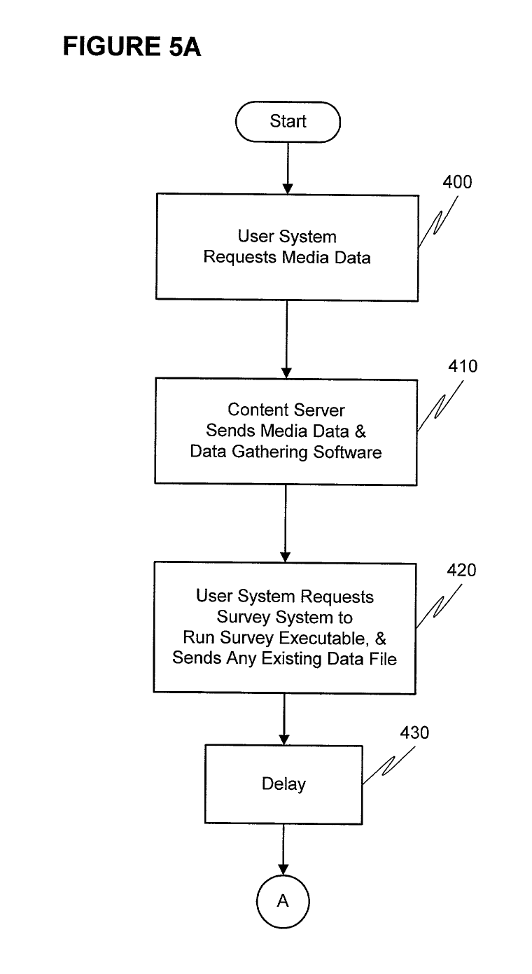

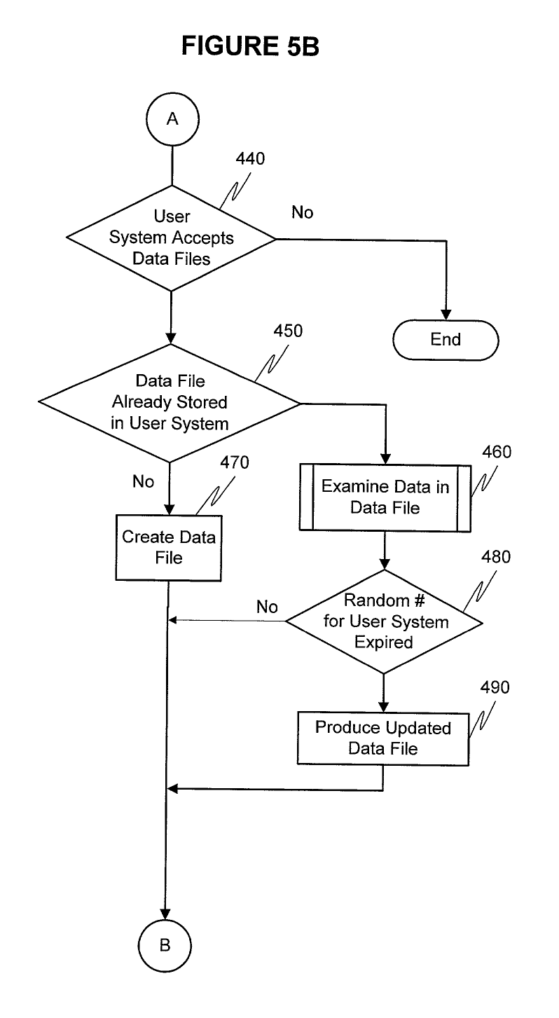

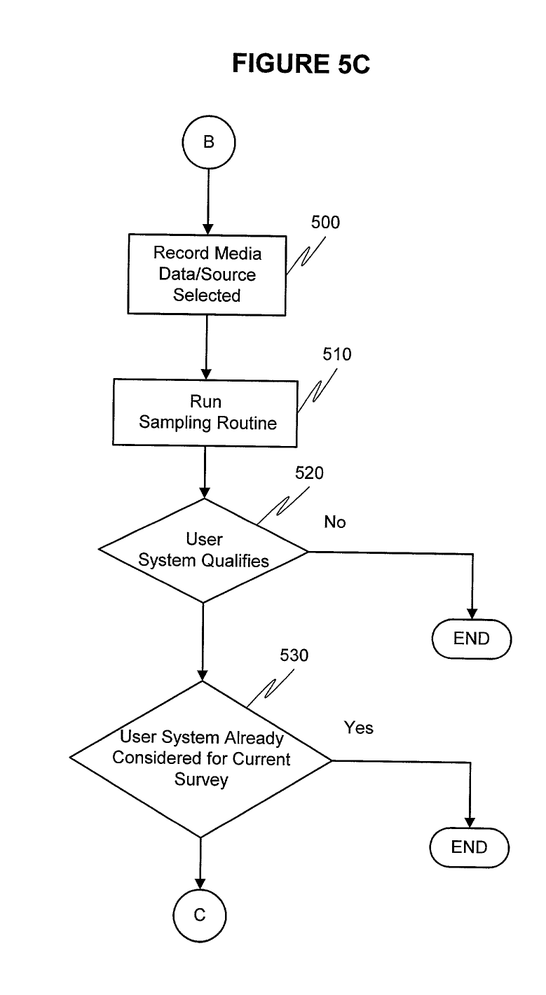

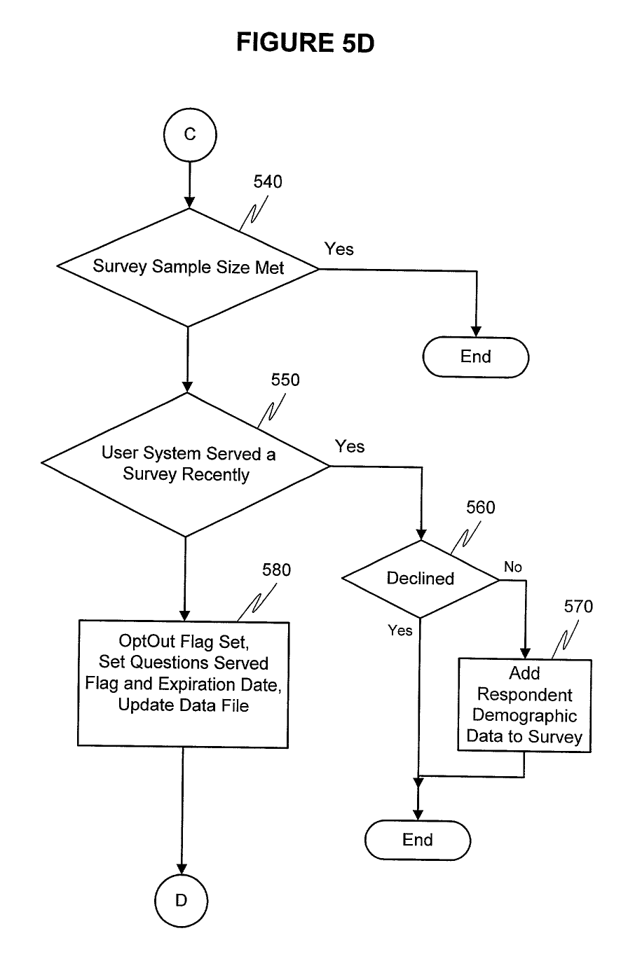

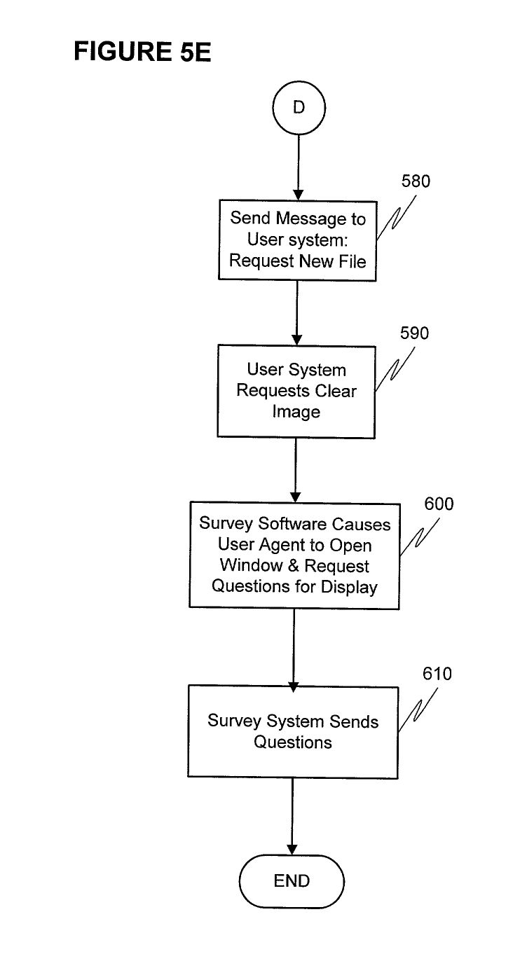

FIGS. 5A through 5E constitute a flow chart illustrating certain modes of operation of the FIG. 1 system in accordance with certain embodiments of the present invention. In such modes of operation, predetermined media data access data as well as user demographic data are gathered. That is, when a user accesses predetermined media data whose usage is being measured, the accompanying data gathering software includes data indicating the identity or source of the predetermined media data. This identity data is supplied to the survey system 50 from the user system 30 and is used both as data representing predetermined media data usage and also as a parameter to control gathering of user demographic data from the user system 30 as described in greater detail below. In certain embodiments, the system is employed to gather access data for Internet content accessed by a user by means of the user system 30. In certain embodiments, the system is employed to gather access data for streaming media data accessed by a user by means of the user system 30.

More specifically, the user system 30 requests media data from one of the content servers 20 by communicating a request therefor via the network 40, as indicated at 400 in FIG. 5A. Where communication between the user system 30 and a content server 20 takes place over the Internet, the request typically is made by a web browser, player, FTP client, or other user agent running on the user system 30. The media data could include streaming media data (audio and/or video), an audio and/or video file, a web page, a game, a data file, an executable file, or other media data.

The request is received by the content server 20 which responds by (1) reading the requested media data from the content database 120 and communicating the same via the network 40 to the user system 30 via the network 40, and (2) reading the data gathering software from the database 130 and communicating the same to the user system 30, as indicated at 410. The data gathering software includes data indicating the predetermined media data being supplied or its source. Preferably, the data gathering software is communicated contemporaneously with the media data. Where the media data is streaming media data, preferably the data gathering software is communicated contemporaneously and asynchronously with the streaming media data. The data gathering software, after receipt by the user system 30, controls the same to communicate with the survey system 50, as described in greater detail below.

The data gathering software contains data indicating a network address and path for a survey executable in the survey system 50 for controlling data gathering communications between the survey system 50 and the user system 30, as well as operations internal to the survey system 50, for gathering survey data from the user system 30. The survey executable may be, for example, a script.

The data gathering software is run by the user system processor 200, which operates under its control to communicate a request by means of the device 220 to the survey system 50 to run the survey executable, as indicated at 420. Along with the request, the user system 30 includes data indicating a network address of the user system 30 and the data indicating the predetermined media data supplied from the content server 20 or its source, which is contained in the data gathering software. Although the communications between the user system 30 and the survey system 50 are conducted advantageously via the network 40, in certain other embodiments such communications are conducted via an alternative system or path.

If the user system 30 has previously participated in a survey with the survey system 50, it will have received a data file, such as a cookie, from the survey system 50 to be saved in the storage 210. This data file will have included an identification code for the user system produced by the survey system 50, as well as randomly generated number data used in the prior survey to determine eligibility to participate in such prior survey, and prior access data for the media data previously accessed by the user system. In addition, the data file includes a questions-served flag indicating whether a request for survey response data was sent to the user system at the time it received the data file, along with an expiration date indicating when the user system is eligible to receive a new survey response request and an expiration date for the randomly generated number in the data file. If the user system saved the previously received data file, its data is communicated by the user system 30 to the survey system 50 along with the request, as indicated at 420.

The survey system 50 records data included with the request received from the user system 30, including the user's network address, the access data indicated by the data gathering software, and data from any data file previously stored in the user system 30, and runs the survey executable. However, before further processing, a predetermined delay is imposed, as indicated at 430. This delay is selected to enable the user system 30 to present the media data received from the content server 20 for at least a predetermined minimum period of time, such as thirty seconds, before an audience member making use of the user system, is presented with a request for submitting survey response data.

In a step 440, the survey system 50 determines whether the user system 30 will accept its data files for storage. If not, the executable is terminated. However, in certain embodiments the access data received from the user system for the presently received media data is retained by the survey system 50 for producing a survey report.

In step 450 of FIG. 5B, the survey system determines if a data file was transmitted with the request from the user system 30. If such a data file exists, as indicated at 460, the received data file is examined to determine if the expiration date included in the file expires after a start date for a current survey and before its survey end date (that is, sometime in the middle of the current survey period). If the expiration date expires in the middle of the current survey period, the logic extends the expiration date to the end of the current survey period. If the expiration date expired before the survey period start date, the questions-served flag is set to zero (initialized for later processing) and the expiration date is set to blank (initialized for later processing). If the expiration date will expire after the current survey period end date, no additional action is taken at this time.

If no data file exists, as indicated at 470, a random number and random number expiration date is generated and other survey fields are generated for later processing. Then the data file is written to the user system.

As indicated at 480, the system determines whether the expiration date of the randomly generated number in the data file has already passed. If it has, at 490 the survey system 50 produces a new randomly generated number and stores it in the data file along with a new expiration date corresponding to the end of a predetermined period for the current survey. These actions qualify the previous response data for consideration in the current survey, depending on fulfillment of further conditions explained herein below.

Then, as seen at 500, the survey system 50 records an indication of the predetermined media data or the source thereof presently requested by the user system 30 as indicated by the data gathering software for use in the current survey.

In a sampling routine indicated at 510, the randomly generated number in the data file determines whether the corresponding user system will be selected for inclusion in the current survey. This routine 510 serves to select a portion of the user systems which access the predetermined media data or its source subject of the current survey, to receive requests for submitting survey response data. This portion is selected based on prior survey experience to (1) qualify a number of user systems sufficient to provide a statistically useful sample size, while (2) minimizing annoyance to audience members. The statistical validity of the survey also requires that the user systems be selected at random.

These requirements are fulfilled in accordance with certain embodiments of the present invention, by selecting a sample size factor to be compared with the random number data assigned to each respective user system. In one embodiment, the randomly generated numbers are constrained to fall between predetermined values, such as zero and one, and the sample size factor is selected as a value within the same range. Those user systems assigned numbers below or above the sample size factor (depending on the embodiment) will be deemed to qualify for the survey, while the remainder will not qualify. For example, if ten percent of user systems receiving predetermined media data are to be selected, the sample size factor can be set at 0.10. Those user systems having randomly generated numbers less than 0.10 will be deemed to qualify for the survey. Those above will not.

In other embodiments, data from a predetermined data set is assigned randomly to qualified user systems. When the assigned, predetermined data is received by the survey system it runs the sampling routine by attempting in a matching routine to match the received data with predetermined sample selection data. The result of the matching routine, either the conclusion that a match is achieved or not, depending on the embodiment, is used either to select the corresponding user system or reject it.

If the user system whose data file is being examined does not qualify, the survey executable is terminated, as indicated at 520. However, if the user system 30 qualifies in step 520, it is next determined in 530 whether the user system has already been considered by the survey system 50 for the current survey. This is accomplished by examining the prior access data stored in the received data file indicating the predetermined media data or source accessed when the data file was created in a prior survey, for a match with the predetermined media data or source of the present survey. If the data match, the executable is terminated. Otherwise, the process continues in a further step 540.

In step 540, the system 50 determines whether a maximum number of survey responses have already been received for the the predetermined media data or source. If so, then the executable is terminated.

If, however, the maximum sample size has not been met, it is further determined whether the user system has been used to decline or complete a survey request in response to receipt of a previous survey presentation message within a predetermined most recent time period, as indicated at 550. Such a time period may be selected, for example, as six months, although a different time period may be employed in the alternative. If the data file received from the user system 30 indicates that a survey has been served within the predetermined most recent time period, it is then determined in step 560 whether survey completion was declined. If so, the executable is terminated. If, however, survey responses were returned by the user system, the demographic data of the respondent included in the responses is added to the current survey, as indicated at 570 and then the survey executable is terminated.

If the user system 30 nevertheless qualifies for the survey, as indicated at 580 the system 50 sets an OptOut flag in the data file for the user system 30 as a default value indicating that the user system 30 declined to complete survey responses for the current survey. As explained below, if the user system in fact provides such responses, the OptOut flag is reset. Also, the questions-served flag of the data file is set indicating that a survey request is being sent to the user system 30 for the current survey, and the expiration date indicating when the user system will next be eligible to receive a request for survey response data is updated for a new time period which, in certain embodiments, is six months later. The updated data file is then stored in the user system 30.

The system 50 communicates a message to the user system 30 to request a new file from the survey system 50, as indicated at 590. The user system responds by requesting the new file from the survey system 50, as indicated at 600. The new file in certain embodiments is a clear GIF image which, when received by the user system 30, causes the data gathering software running thereon to open a new window in a visual display of the user system 30 and to request a survey presentation file from the survey system 50, as indicated at 610.

Upon receipt of this new request from the user system 30, the survey system 50 communicates the survey presentation file to the user system 30, as indicated at 620, and then terminates the executable. The survey presentation file includes instructions which control the user system 30 to present a survey response request presentation to one or more audience members. Such instructions may take the form, for example, of a document expressed in an appropriate markup language. The presentation in certain embodiments requests demographic data from the audience member or members. In others it requests media usage data. In still others it requests both. The presentation includes one or more interactive survey information request response means, such as a software button, radio button, menu, response form or the like, to receive survey response data for an audience member in the user system, and to control the user system to communicate the received survey data to the survey system 50.

In certain embodiments, the system 50 sends one or more presentations to the user system 30 reminding the user to complete a survey questionnaire, explaining the survey purpose and procedure, the relevant privacy policy, and/or providing incentives to the user to complete the questionnaire.

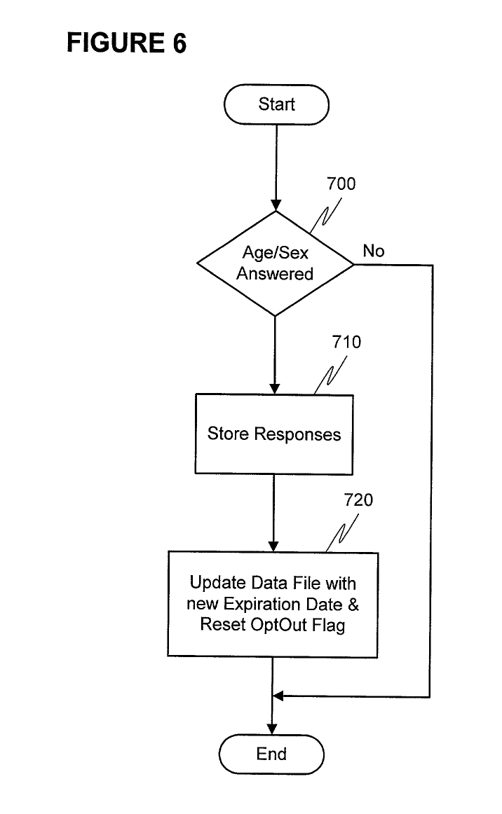

Upon receipt of survey response data from the user system 30, in certain embodiments, the survey system 50 processes the same in accordance with FIG. 6. As indicated at 700, the system 50 determines whether the response data includes both age and sex data for the user. If not, the process is terminated. Since the OptOut flag for the user sytem's data file had previously been set, upon the end of this process the data file will indicate correctly that the user system did not provide a useful response and is thus deemed to have opted out of the survey.

If however, the age and sex data have been provided by the user system, the response data received therefrom are stored by system 50 for use in the current survey, as indicated at 710. Then the data file in the user system is modified to reflect a new expiration date indicating when the user system will be eligible for a new request and to reset the OptOut flag, as indicated at 720.

In the case of user systems which do not already store data files received from the survey system 50, but which do accept such files for storage therein, from step 450 of FIG. 5B the system proceeds to create a new data file for the user system including a user system identification code, a randomly generated number, an expiration date for the randomly generated number, a questions-served flag, an expiration date for indicating future user system eligibility, an OptOut flag and an identification code for the media data or source presently accessed by the user system. In all other respects, the procedures as depicted in FIGS. 5A through 5E and 6 are conducted as described herein above.

Various alternative embodiments are also within the scope of the present invention. In certain ones of such embodiments, a response is not requested of a user of the user system. Instead, data is automatically obtained from the user system without intervention of the user and communicated to a survey system to be stored therein.

Although the invention has been described with reference to a particular arrangement of devices, features and the like, these are not intended to exhaust all possible arrangements or features, and indeed many other modifications and variations will be ascertainable to those of skill in the art.

What is claimed is:

1. A method for surveying media data audiences, comprising:
communicating media data from a content server to a user system via a network;
communicating data gathering software associated with the media data from the content server to the user system via the network;
without user intervention, communicating an audience survey message from the user system under the control of the data gathering software to an audience surveying system;
in response to the audience survey message, communicating a survey presentation message from the audience surveying system to the user system, the survey presentation message including survey presentation instructions;
controlling the user system by means of the survey presentation instructions to produce a survey presentation for a media audience member;
receiving survey response data for an audience member in the user system; and
communicating the survey response data from the user system to the audience surveying system via the network.

2. The method of claim 1, wherein the media data comprises Internet content.

3. The method of claim 2, wherein the Internet content comprises streaming media data.

4. The method of claim 3, wherein the content server communicates the data gathering software to the user system while communicating the streaming media data thereto.

5. The method of claim 4, wherein the survey presentation is delayed for a predetermined minimum delay period after an initial receipt of the streaming media data by the user system.

6. The method of claim 5, wherein the predetermined minimum delay period is produced by the audience surveying system.

7. The method of claim 1, wherein the survey presentation instructions control the user system to present at least one survey information request and an interactive survey information request response means.

8. The method of claim 1, wherein the audience surveying system determines an eligibility of the user system to receive the survey presentation message by assigning a random value data to the user system and comparing the random value data to a predetermined sample size factor to determine the eligibility of the user system.

9. The method of claim 1, wherein the audience surveying system determines an eligibility of the user system to receive the survey presentation message based on prior receipt of a previous survey presentation message by the user system within a predetermined time period.

10. The method of claim 9, wherein the audience surveying system determines the eligibility of the user system to receive the survey presentation message based on at least one of inputting survey response data in the user system in response to the previous survey presentation message and failure to input survey response data in the user system in response to the previous survey presentation message.

11. A system for surveying media data audiences, comprising:
media data communicating means for communicating media data from a content server to a user system via a network;
software communicating means for communicating data gathering software associated with the media data from the content server to the user system via the network;
means for communicating an audience survey message without user intervention from the user system under the control of the data gathering software to an audience surveying system;
means for communicating a survey presentation message from the audience surveying system to the user system in response to the audience survey message, the survey presentation message including survey presentation instructions;
presenting means for producing a survey presentation for a media audience member under the control of the survey presentation instructions;
receiving means for receiving survey response data for an audience member in the user system; and
means for communicating the survey response data from the user system to the audience surveying system.

12. The system of claim 11, wherein the media data comprises Internet content.

13. The system of claim 12, wherein the Internet content comprises streaming media data.

14. The system of claim 13, wherein the software communicating means is operative to communicate the data gathering software to the user system while the media data communicating means communicates the streaming media data thereto.

15. The system of claim 14, comprising delay means to delay producing the survey presentation by the presenting means for a predetermined minimum delay period after initial receipt of the streaming media by the user system.

16. The system of claim 15, wherein the delay means is part of the audience surveying system.

17. The system of claim 11, wherein the presenting means is operative to produce the survey presentation to include at least one survey information request and an interactive survey information request response means.

18. The system of claim 11, comprising eligibility determining means for determining an eligibility of the user system to receive the survey presentation message by assigning random value data to the user system and comparing the random value data to a predetermined sample size factor to determine the eligibility of the user system.

19. The system of claim 11, comprising eligibility determining means for determining an eligibility of the user system to receive the survey presentation message based on prior receipt of a survey presentation message by the user system within a predetermined time period.

20. The system of claim 19, wherein the eligibility determining means is operative to determine the eligibility of the user system to receive the survey presentation message based on at least one of a receipt by the receiving means of survey response data from the user system prior to its receipt of the survey presentation message and a failure to receive survey response data thereby from the user system prior to its receipt of the survey presentation message.

21. A method for surveying media data audiences, comprising:
receiving media data at a user system from a content server communicated via a network;
receiving data gathering software associated with the media data at the user system from the content server communicated via the network;
without user intervention, communicating a media audience message from the user system under the control of the data gathering software to an audience surveying system;
receiving a survey presentation message at the user system from the audience surveying system, the survey presentation message including survey presentation instructions;
controlling the user system by means of the survey presentation instructions to produce a survey presentation for an audience member;
receiving survey response data for an audience member in the user system; and
communicating the survey response data from the user system to the audience surveying system.

22. The method of claim 21, wherein the media data comprises Internet content.

23. The method of claim 22, wherein the Internet content comprises streaming media data.

24. The method of claim 23, wherein the data gathering software is received while the streaming media data is being received.

25. The method of claim 24, wherein the survey presentation is delayed for a predetermined minimum delay period after an initial receipt of the streaming media data.

26. The method of claim 21, wherein the survey presentation instructions control the user system to present at least one survey information request and to present an interactive survey information request response means.

27. A system for gathering and communicating media data audience survey data by means of a user system, comprising:
means for receiving media data at a user system from a content server via a network;
means for communicating a media audience message without user intervention from the user system to a survey system indicating receipt of the media data;
presentation control means for controlling the user system to produce a survey presentation for an audience member based on a survey request message received from the survey system;
means for receiving survey response data for an audience member in the user system; and
means for communicating the survey response data from the user system to the survey system.

28. The system of claim 27, wherein the media data comprises Internet content.

29. The system of claim 28, wherein the Internet content comprises streaming media data.

30. The system of claim 27, wherein the presentation control means is operative to control the user system to present at least one survey information request and to present an interactive survey information request response means.

31. A method for surveying media data audiences, comprising:
receiving an audience survey message from a user system identifying media data received thereby from a content server;
producing user system eligibility data by assigning random value data to the user system and comparing the random value data to a predetermined sample size value;
in response to the audience survey message and based on the user system eligibility data, communicating a survey presentation message to the user system, the survey presentation message including survey presentation instructions; and
receiving survey response data from the user system.

32. The method of claim 31, comprising delaying the communicating of the survey presentation message for a predetermined minimum time period after receipt of the audience survey message.

33. The method of claim 31, wherein the survey presentation instructions include instructions to the user system to present at least one survey information request and to present an interactive survey information request response means.

34. The method of claim 31, wherein the user system eligibility data is produced based on previous communication of a survey presentation message to the user system.

35. The method of claim 34, wherein the user system eligibility data is produced based on at least one of receipt of survey response data in response to the previously communicated survey presentation message and failure to receive survey response data in response thereto.

36. The method of claim 31, wherein the media data comprises Internet content.

37. The method of claim 36, wherein the Internet content comprises streaming media data.

38. A system for surveying media data audiences, comprising:
means for receiving an audience survey message from a user system identifying media data received thereby from a content server;
means for producing user system eligibility data by assigning random value data to the user system and comparing the random value data to a predetermined sample size value;
means for communicating a survey presentation message to the user system in response to the audience survey message and based on the user system eligibility data, the survey presentation message including survey presentation instructions; and
means for receiving survey response data from the user system.

39. The system of claim 38, comprising means for delaying communicating the survey presentation message for a predetermined minimum time period after receipt of the audience survey message.

40. The system of claim 38, wherein the survey presentation instructions include instructions to the user system to present at least one survey information request and to present an interactive survey information request response means.

41. The system of claim 38, comprising means for determining an eligibility of the user system to receive the survey presentation message based on a previous communication of a survey presentation message to the user system.

42. The system of claim 41, wherein the means for determining eligibility is operative to determine the eligibility of the user system based on at least one of receipt of survey response data in response to the previously communicated survey presentation message and failure to receive survey response data in response thereto.

43. The system of claim 38, wherein the media data comprises Internet content.

44. The system of claim 43, wherein the Internet content comprises streaming media data.

45. A method for gathering data for producing media data audience reports, comprising:
communicating media data from a content server to a user system via a network;
communicating data gathering software associated with the media data from the content server to the user system via the network;
without user intervention, communicating a media audience message from the user system under the control of the data gathering software to an audience surveying system; and
storing media audience data in the audience surveying system based on the media audience message.

46. The method of claim 45, wherein the media data comprises Internet content.

47. The method of claim 46, wherein the Internet content comprises streaming media data.

48. The method of claim 47, wherein the content server communicates the data gathering software to the user system while communicating the streaming media data thereto.

49. The method of claim 45, wherein the media audience message includes the media audience data.

50. The method of claim 49, wherein the media audience data comprises user system identification data.

51. The method of claim 45, wherein the media audience message is communicated from the user system to the audience surveying system via the network.

52. A system for gathering data for producing media data audience reports, comprising:
media data communicating means for communicating media data from a content server to a user system via a network;
software communicating means for communicating data gathering software associated with the media data from the content server to the user system via the network;
media audience message communicating means for communicating a media audience message from the user system under the control of the data gathering software and without user intervention to an audience surveying system; and
means for storing media audience data in the audience surveying system based on the media audience message.

53. The system of claim 52, wherein the media data comprises Internet content.

54. The system of claim 53, wherein the Internet content comprises streaming media data.

55. The system of claim 54, wherein the software communicating means is operative to communicate the data gathering software to the user system while the streaming media data is communicated to the user system.

56. The system of claim 52, wherein the media audience message includes the media audience data.

57. The system of claim 56, wherein the media audience data comprises user system identification data.

58. The system of claim 52, wherein the media audience message communicating means is operative to communicate the media audience message to the audience surveying system via the network.

59. A method for producing data for use in preparing media data audience reports, comprising:
receiving media data at a user system from a content server communicated via a network;
receiving data gathering software associated with the media data at the user system from the content server communicated via the network; and
communicating a media audience message from the user system under the control of the data gathering software and without user intervention to an audience surveying system.

60. The method of claim 59, wherein the media data comprises Internet content.

61. The method of claim 60, wherein the Internet content comprises streaming media data.

62. The method of claim 61, wherein the user system receives the data gathering software from the content server while receiving the streaming media data therefrom.

63. The method of claim 59, wherein the media audience message comprises media usage data.

64. The method of claim 63, wherein the media usage data comprises user system identification data.

65. A system for producing data for use in preparing media data audience reports, comprising:
media data receiving means for receiving media data at a user system from a content server communicated via a network;
software receiving means for receiving data gathering software associated with the media data at the user system from the content server communicated via the network; and
media audience message communicating means programmed by the data gathering software to communicate a media audience message without user intervention from the user system to an audience surveying system.

66. The system of claim 65, wherein the media data comprises Internet content.

67. The system of claim 66, wherein the Internet content comprises streaming media data.

68. The system of claim 67, wherein the software receiving means is operative to receive the data gathering software from the content server while the media data receiving means receives the streaming media data.

69. The system of claim 65, wherein the media audience message communicating means is operative to communicate media usage data to the audience surveying system.

70. The system of claim 69, wherein the media usage data comprises user system identification data.

71. A method of controlling a user system to provide media data usage data to an audience surveying system, comprising:
communicating media data from a content server to a user system via a network; and
communicating data gathering software associated with the media data from the content server to the user system via the network;
wherein the data gathering software is communicated asynchronously with respect to the media data from the content server.

72. The method of claim 71, wherein the media data comprises Internet content.

73. The method of claim 72, wherein the Internet content comprises streaming media data.

74. The method of claim 73, wherein the content server communicates the data gathering software to the user system while communicating the streaming media data thereto.

75. A system for controlling a user system to provide media data usage data to an audience surveying system, comprising:
means for communicating media data from a content server to a user system via a network; and
software communicating means for communicating data gathering software associated with the media data from the content server to the user system via the network;
wherein the software communicating means serves to communicate the data gathering software from the content server asynchronously with respect to the media data.

76. The system of claim 75, wherein the media data comprises Internet content.

77. The system of claim 76, wherein the Internet content comprises streaming media data.

78. The system of claim 77, wherein the software communicating means is operative to communicate the data gathering software to the user system while the streaming media data is communicated thereto.

79. A system for gathering data for measuring a media data audience, comprising:
a user system; and
software received contemporaneously with media data and loaded onto the user system for communicating an indication of media data usage by the user system without user intervention.

80. The system of claim 79, wherein the media data comprises Internet content.

81. The system according to claim 80, wherein the Internet content comprises streaming media data.

82. A method of gathering data for a media data usage survey, comprising:
producing random value data;
assigning the random value data to a media data user system;
producing selection data based on a desired sample size for a media usage survey;
determining whether the media data user system is eligible for the media usage survey based on the random value data and the selection data; and
if the media data user system is eligible for the media usage survey, including media usage data from the media data user system in the media usage survey.

83. The method of claim 82, wherein including media usage data comprises including demographic data concerning a user of the media data user system in the media usage survey.

84. The method of claim 82, wherein including media usage data comprises including data concerning media data supplied to the media data user system in the media usage survey.

85. The method of claim 82, wherein including media usage data comprises including data concerning Internet content supplied to the media data user system in the media usage survey.

86. The method of claim 82, wherein including media usage data comprises including data concerning streaming media data supplied to the media data user system in the media usage survey.

87. The method of claim 82, wherein assigning the random value data comprises communicating the random value data to the media data user system and storing the random value data in the media data user system.

88. The method of claim 82, wherein producing random value data comprises producing a media data user system number within a predetermined range of numbers.

89. The method of claim 88, wherein producing selection data comprises producing the selection data as a numerical value within the predetermined range of numbers and determining eligibility of the user system by comparing the numerical value with the media data user system number.

90. A system for gathering data for a media data usage survey, comprising:
random value data producing means for producing random value data;
random value assigning means for assigning the random value data to a media data user system;
selection data producing means for producing selection data based on a desired sample size for a media usage survey;
eligibility determining means for determining whether the media data user system is eligible for the media usage survey based on the random value data and the selection data; and
means for including media usage data from the media data user system in the media usage survey on the condition that the media data user system is determined to be eligible for the media usage survey.

91. The system of claim 90, wherein the means for including media usage data is operative to include demographic data concerning a user of the media data user system in the media usage survey.

92. The system of claim 90, wherein the means for including media usage data is operative to include data concerning media data supplied to the media data user system in the media usage survey.

93. The system of claim 90, wherein the means for including media usage data is operative to include data concerning Internet content supplied to the media data user system in the media usage survey.

94. The system of claim 90, wherein the means for including media usage data is operative to include data concerning streaming media data supplied to the media data user system in the media usage survey.

95. The system of claim 90, wherein the random value data assigning means comprises means for communicating the random value data to the media data user system and means for storing the random value data in the media data user system.

96. The system of claim 90, wherein the random value producing means comprises means for producing a media data user system number within a predetermined range of numbers.

97. The system of claim 96, wherein the selection data producing means comprises means for producing the selection data as a numerical value within the predetermined range of numbers and the eligibility determining means comprises means for determining eligibility of the media data user system by comparing the numerical value with the media data user system number.
